(19) United States
(12) Patent Application Publication
(10) Pub. No.: US 2015/0209617 A1
(43) Pub. Date: Jul. 30, 2015

(54) FITNESS EQUIPMENT COMBINING WITH A CLOUD SERVICE SYSTEM

(71) Applicant: Wanin International Co., Ltd., Taichung City (TW)

(72) Inventor: Cheng-Hao Hsiao, Taichung City (TW)

(73) Assignee: Wanin Interantional Co., Ltd., Taichung City (TW)

(21) Appl. No.: 14/165,033

(22) Filed: Jan. 27, 2014

(51) Int. Cl. A63B 24/00; H04L 29/08

(52) U.S. Cl. CPC A63B 24/0087; H04L 67/10

(57) ABSTRACT

A fitness equipment combining with a cloud service system includes a control device, an exercise unit, a transmission module and a display module. The cloud service system includes a transceiver server, a computing server and a storage server. A control signal and a power signal which are generated respectively by the control device and the exercise unit according to manipulation and operation of a user are transmitted via the transmission module to the transceiver server. The computing server establishes an exercise model according to the control signal and power signal and combines the exercise model with an information model stored in the storage server to generate a display signal. The display signal is inputted to the display module to generate an interactive image. Accordingly, the cloud service system can be simultaneously connected with multiple fitness equipment for competition, so as to create much fun for exercise.

### FIELD OF THE INVENTION

The present invention relates to a fitness equipment, and particularly to a fitness equipment combining with a cloud service system that allows different users to simultaneously exercise and compete against one another.

### BACKGROUND OF THE INVENTION

Doing exercise is an important way to maintain a healthy body. However, as modern people lead busy daily lives, one may find it difficult to set aside time to exercise in stadiums or exercise fields. Therefore, various indoor fitness equipments, such as treadmills, spinning bikes, steppers, and rowing machines, have become common in households.

Generally, after purchasing an indoor fitness equipment, a user is quite enthusiastic in using such indoor fitness equipment. As time goes by, the user may feel bored about using the indoor fitness equipment and become less willing to utilize the indoor fitness equipment, such that the utilization rate of the indoor fitness equipment is significantly lowered. In this case, the user needs to be diverted from the boredom through assistance of entertainment media such as the television, magazines or cell phones. As such, the user may not focus enough on the exercise, in a way that not only exercise results are reduced but also risks of exercise injuries are increased. Eventually, the indoor fitness equipment may be discarded at a corner of a house and covered in dust, achieving no effects to facilitate exercise at all.

It is apparent that a user may easily feel bored about the above conventional fitness equipment. Thus, a fitness equipment is later combined with reality video to provide interaction effects. While working out on the later fitness equipment, the user may also enjoy the reality video, and the utilization rate of the later fitness equipment may be increased for an initial period. However, the reality video is just pre-recorded images and does not offer real-time dynamic changes. Therefore, the user may still feel bored and become weary after repeated use.

### SUMMARY OF THE INVENTION

Therefore the primary object of the present invention is to provide a fitness equipment allowing multiple users to simultaneously play a game to achieve a competition effect, thereby stimulating interest of users and at the same time achieving effects of exercise and entertainment.

To achieve the above object, a fitness equipment combining with a cloud service system are provided by the present invention. The cloud service system includes a transceiver server, a computing server and a storage server. The fitness equipment includes a control device, an exercise unit, a transmission module and a display module.

In the fitness equipment of the present invention, the control device generates a control signal according to manipulation of a user, and the exercise unit generates a power signal according to operation of the user. The storage server of the cloud service system stores an information model.

The control signal and the power signal are transmitted via the transmission module to the transceiver server of the cloud service system. According to the control signal and the power signal of the fitness equipment, the computing server establishes an exercise model and combines the exercise model with the information model stored in the storage server to generate a display signal. The display signal is inputted into the display module to generate an interactive image.

Accordingly, the cloud service system is able to connect with a plurality of fitness equipment, and the computing server of the cloud service system establishes exercise models according to the control signals and the power signals of the plurality of fitness equipment respectively. Each of the exercise models is combined with the information model stored in the storage server to generate display signals in different viewing angles designated by the plurality of fitness equipment. The display signals are then inputted into the display modules of the fitness equipment respectively to generate interactive images. That is to say, users of the plurality of fitness equipment are enabled to compete with one another through the cloud service system, thereby enhancing the fun of exercise and promoting the willingness for exercise.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view of a fitness equipment of the present invention;

FIG. 2 is a partial top view of a fitness equipment of the present invention;

FIG. 3 is a side view of a fitness equipment of the present invention;

FIG. 4 is a block diagram of a cloud service system of the present invention;

FIG. 5 is a first schematic diagram according to an embodiment of the present invention;

FIG. 6 is a second schematic diagram according to an embodiment of the present invention;

FIG. 7 is a third schematic diagram according to an embodiment of the present invention;

FIG. 8 is a fourth schematic diagram according to an embodiment of the present invention;

FIG. 9 is a block diagram of a cloud service system according to another embodiment of the present invention.

### DETAILED DESCRIPTION OF THE PREFERRED EMBODIMENTS

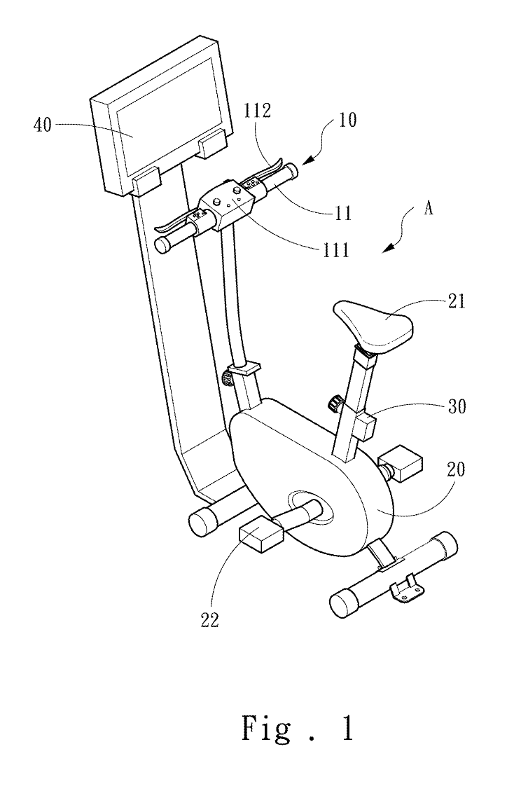

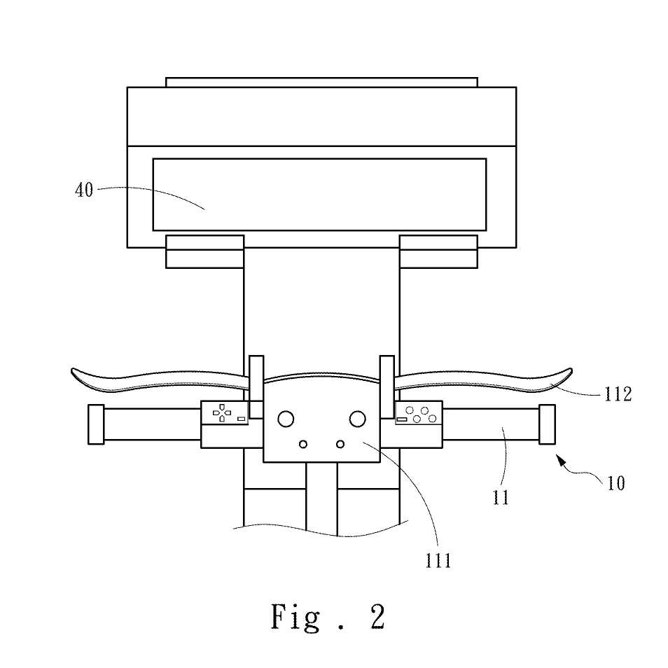

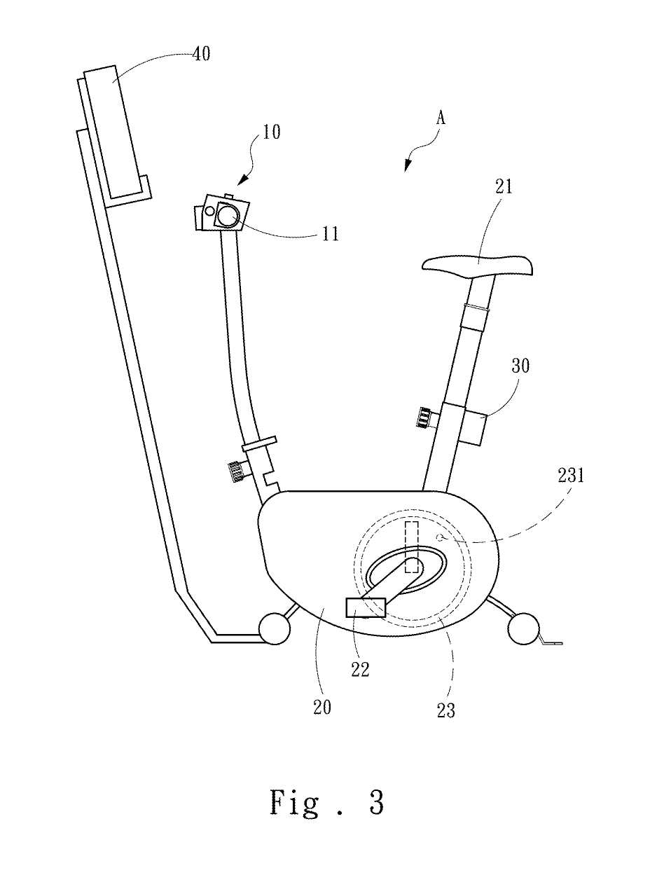

Referring to FIGS. 1, 2 and 3, a fitness equipment A of the present invention mainly includes a control device 10, an exercise unit 20, a transmission module 30 and a display module 40.

The control device 10 of the fitness equipment A generates a control signal according to manipulation of a user. The exercise unit 20 generates a power signal according to operation of the user.

For example, the exercise unit 20 may be a spinning bike, and includes a seat 21, a pedal 22 and a flywheel 23. When the user uses the exercise unit 20, the user is seated on the seat 21 and treads on the pedal 22 to drive the flywheel 23 to rotate. The flywheel 23 includes a rotational speed sensor 231 to detect a rotational speed of the flywheel 23 to generate the power signal.

The rotational speed sensor 231 of the present invention may be implemented by a reed switch sensor. In principle, a magnetic conductor is disposed on the flywheel 23 to generate a magnetic field change. When the magnetic conductor passes through the reed switch sensor, the reed switch sensor detects the magnetic field change. Thus, the number of rotations of the flywheel 23 per minute can be calculated according to the number of magnetic field change detected by the reed switch sensor per minute. Further with a diameter of the flywheel 23, the rotational speed and an accumulated mileage can be calculated.

The control device 10 may be integrated with the seat 21, so as to use a shift and a tilt of the seat 21 caused by a shift of the center of gravity of a user to control braking and angle turning of the fitness equipment A (the spinning bike). Alternative, as shown in the diagram, the control device 10 may be a handle 11 to control the braking and the angle turning of the fitness equipment A. The handle 11 includes a function key set 111 and a brake device 112. The function key set 111 allows a user to control the fitness equipment A (the spinning bike) by setting orders such as selection, confirmation, start and movement. The brake device 112 serves for braking purposes, and may also be controlled by the control device 10 to be automatically activated and controlled a braking force, so as to simulate conditions that a bike are going uphill.

The brake device 112 may be caliper brakes which include two brake linings at two sides of the flywheel 23 respectively to clip the flywheel 23 and to generate a resistive force from a frictional force. Further, the brake device 112 may also be a direct pressurized brake which includes a brake lining directly pressurizing upon the flywheel 23 to generate a resistive force from a frictional force. Further, the brake device 112 may also be a magnetic controlled brake which uses a magnetic force generated at a contact surface between a magnet and the flywheel 23 to form a resistive force. The magnetic force becomes larger as the contact surface between the magnet and the flywheel 23 gets larger, i.e., the resistive force gets larger. Notably, any structure that is capable of decelerating or stopping the rotations of the flywheel 23 may be implemented as the brake device 112 of the present invention.

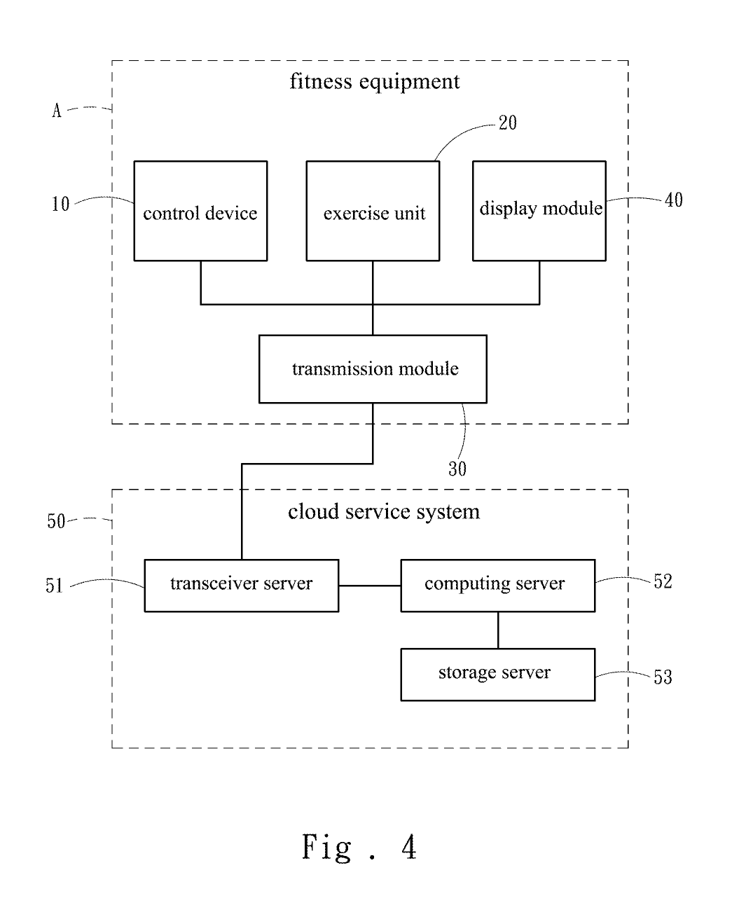

Referring to FIGS. 4, 5, 6 and 7, a cloud service system 50 of the present invention includes a transceiver server 51, a computing server 52 and a storage server 53. The storage server 53 of the cloud service system 50 stores an information model 91.

The control signal and the power signal of the fitness equipment A are transmitted via the transmission module 30 to the transceiver server 51 of the cloud service system 50. According to the control signal and the power signal of the fitness equipment A, the computing server 52 establishes an exercise model 90, and combines the exercise model 90 with the information model 91 stored in the storage server 53 to generate a display signal. The display signal is inputted into the display module 40 to generate an interactive image. The transmission module 30 may be implemented by Wi-Fi, WiMAX, LET, UWB, ZigBee, Bluetooth, microwave, infrared or radio-frequency. The display module 40 may be a common display device, a television, or a smart television with Internet functions.

The cloud service system 50 is able to connect with a plurality of fitness equipment A. In case of the cloud service system 50 connects to a plurality of fitness equipment A, the computing server 52 of the cloud service system 50 may establish exercise models 90 according to the control signals and the power signals of the plurality of fitness equipment respectively, and combine the exercise models 90 with the information model 91 to generate display signals in different viewing angles designated by the plurality of fitness equipments A respectively to generate interactive images.

The components of the fitness equipment A and the cloud service system 50 are as described above. Details of a preferred embodiment of the present invention are further given below.

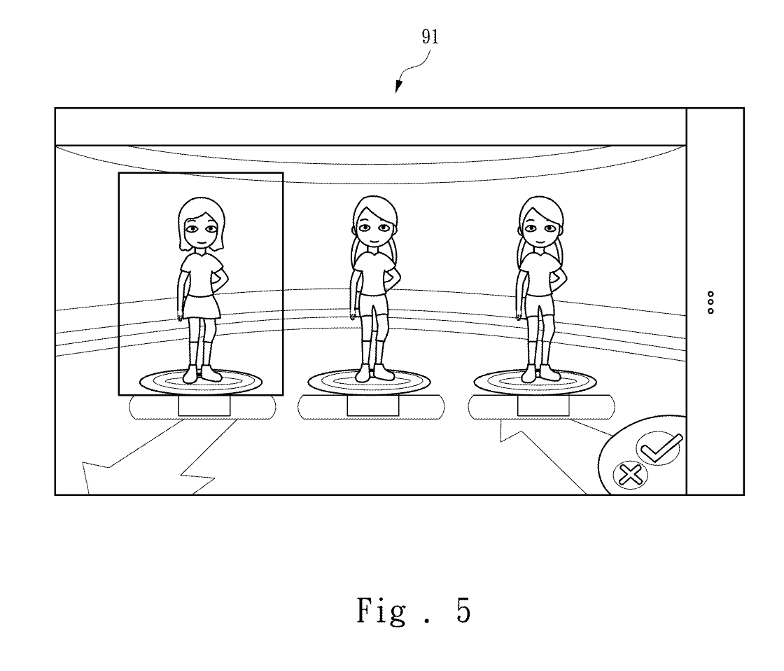

As shown in FIGS. 5, 6 and 7, to operate the fitness equipment A of the present invention, a user needs to first connect the fitness equipment A with the cloud service system 50 through a verification code (e.g., a user's account and password or a PIN number) provided by a developer. In a most preferred embodiment, the cloud service system 50 of the present invention is a client/server network. In other embodiments, multi-tier networks or peer-to-peer networks are also applicable to the present invention.

After the user establishes the above connection, the fitness equipment A sends a request signal to the transceiver server 51 of the cloud service system 50, and the request signal is transmitted to the computing server 52 to proceed to verify user's identification. When the identity is successfully verified, parameters of the user are accessed from the storage server 53 and transmitted via the transceiver server 51 to the fitness equipment A. As such, the user is allowed to play multi-player online games. Via the control device 10 and the display module 40 of the fitness equipment A, the user is allowed to perform operation such as selection, confirmation, start, movement and braking through an interface of the display module 40. Signals of the operation are transmitted via the transmission module 30 to be processed by the computing server 52 for distributed computing processing. For example, the information model 91 stored in the storage server 53 may be built-in with a plurality=of user characters for a user to select (as shown in FIG. 5).

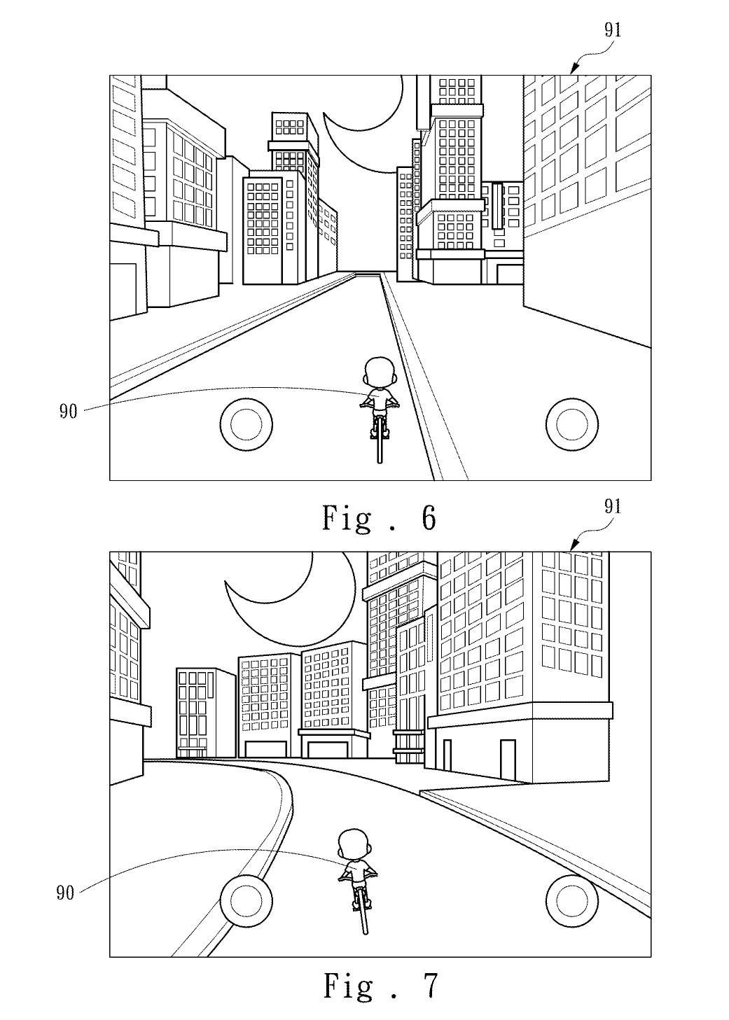

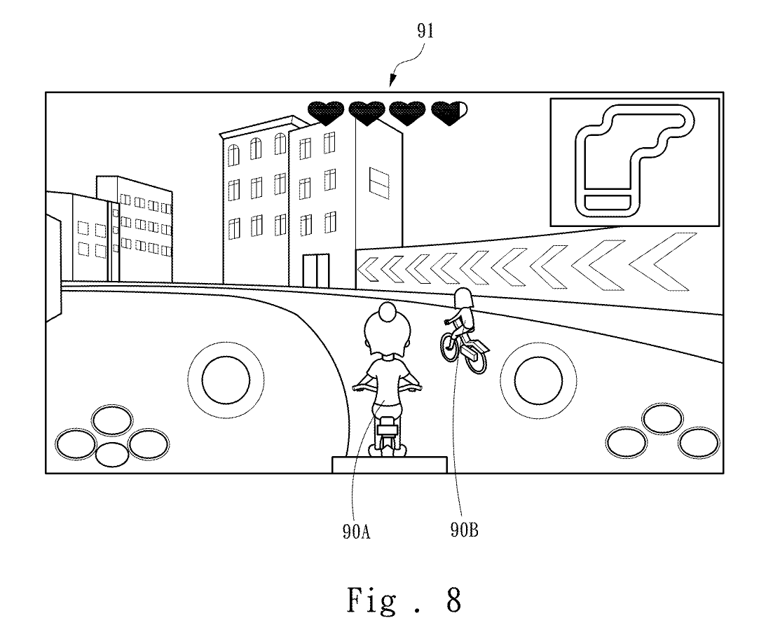

When the user exercises on the fitness equipment A, the control signal and the power signal are respectively generated through the control device 10 and the exercise unit 20, and are transmitted via the transmission module 30 to the transceiver server 51. According to the received data (the power signal and the control signal), the computing server 52 establishes an exercise module 90. The computing server 52 then reads the information model 91 (e.g., map information) from the storage server 53, and combines the exercise model 90 with the information model 91 to form an virtual position that corresponds to a position and an exercise status of the fitness equipment A in the information model 91. That is to say, the computing server 52 generates a display signal in a viewing angle designated by the fitness equipment A, and the display signal is inputted into the display module 40 of the fitness equipment A to generate an interactive image (as shown in FIG. 6). When the user makes a turn by using the control device 10 or changes the operation strength of the exercise unit 20, a new control signal and a new power signal are generated instantly. According to the new control signal and the new power signal, the computing server 52 modifies the exercise model 90 and combines the modified exercise model 90 into the information model 91 to generate a new display signal for further generating a new interactive image (as shown in FIG. 7).

FIG. 8 shows that different users compete against one another. In this embodiment, the different users utilize the same information model 91 but have different exercise models 90A and 90B. Through excitement of games and the sense of honor, different users are attracted to utilize the fitness equipment A to achieve the goal of exercise and fitness.

A feature of the present invention is that all logic computations are processed by the cloud service system 50, and the interactive images generated from the computation results are transmitted to and displayed by the display module 40. Thus, the cloud service system 50 is capable of connecting to multiple fitness equipment A (multiple users), and providing the users with various cloud services such as multi-player games, social interactions and chat communications.

In addition to storing various parameters of different users, the storage server 43 may further store information and data required by other cloud services, e.g., live maps or virtual maps of different places around the world as required by multi-player online games. The live maps can be established by video recording or photographing, and are stored in the storage server 53 in advance to provide the user, who is riding on fitness equipment A, an experience of realistic sensations as if riding on streets of a desired destination.

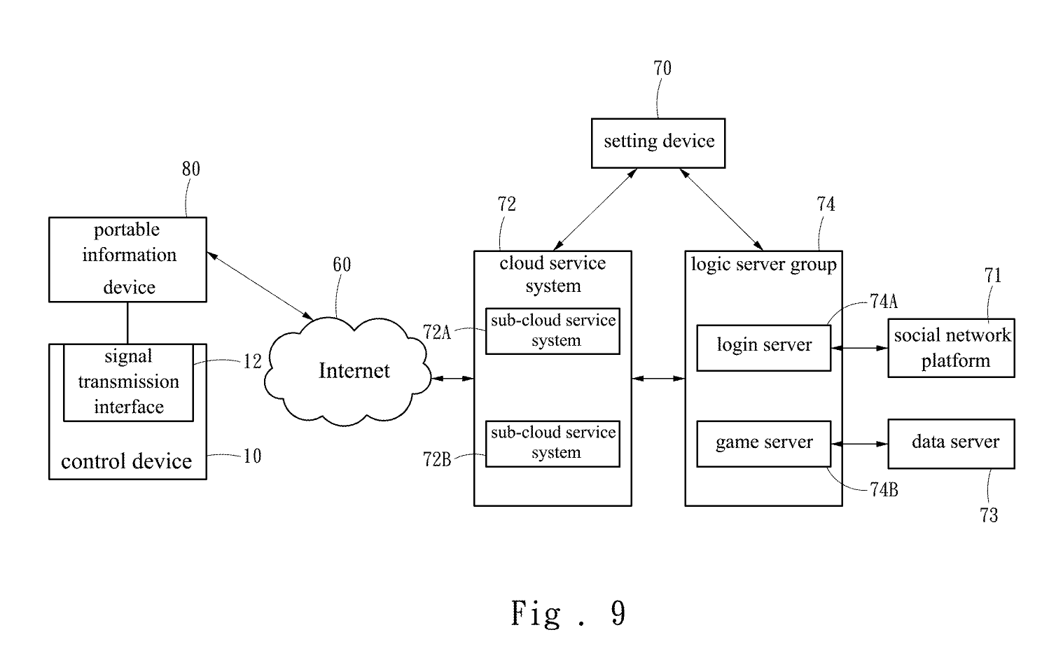

FIG. 9 shows another embodiment of the present invention. In FIG. 9, the control device 10 may further include a signal transmission interface 12. The signal transmission interface 12 may be a Bluetooth or an USB interface, and is connected to a portable information device 80. The present invention may further include a cloud service system 72, a logic server group 74 and a setting device 70. The setting device 70 manages the cloud service system 72 and the logic server group 74 as well as a connection protocol between the cloud service system 72 and the logic server group 74, and may add a new cloud service system or logic server to increase the capacity for more users. As shown in FIG. 9, the cloud service system 72 may include at least two sub-cloud service systems 72A and 72B.

On the other hand, the setting device 70 may be used to add more services, e.g., adding an audio chat server in the logic server group 74, so that all users are allowed to access the new audio service through the sub-cloud server systems 72A and 72B of the cloud service system 72.

When a user requests for services via the sub-cloud service systems 72A and 72B, the sub-cloud service systems 72A and 72B establish connections with the logic server group 74 via the setting device 70 to execute service tasks. Further, the logic server group 74 includes a login server 74A and a game server 74B for respectively providing login and game services.

The login server 74A may also be connected to a social network platform 71, so that a user is allowed to directly login by an account and a password of the social network platform 71 and thus eliminating complications of establishing a new account. The game server 74B may exchange data with a data server 73 to store data.

Further, the portable information device 80 may be a smart phone or a tablet computer to replace the display module 40. The portable information device 80 may connect with the sub-cloud service systems 72A and 72B through the Internet 60, thus the utilization convenience of the present invention is further improved.

In conclusion, the present invention allows multiple users to compete against one another via the fitness equipment and the cloud service system of the present invention. More specifically, the present invention enables different users to carry out multi-player games to enhance fun and attraction of the fitness equipment. Further, the present invention also provides chatting and social interaction functions for enhancing the fun of exercise, thereby effectively increasing the willingness for exercise and preventing boredom caused by repeated and monotonous operations.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A fitness equipment combining with a cloud service system which comprises a transceiver server, a computing server and a storage server; the fitness equipment comprising:
a control device, generating a control signal according to manipulation of a user;
an exercise unit, generating a power signal according to operation of the user;
a transmission module, transmitting the control signal and the power signal to the transceiver server; and
a display module;
wherein, the computing server establishes an exercise model according to the control signal and the power signal of the fitness equipment, and combines the exercise model with an information model stored in the storage server to generate a display signal, the display signal being inputted into the display module to generate an interactive image.

2. The fitness equipment combining with the cloud service system of claim 1, wherein the exercise unit comprises a seat, a pedal and a flywheel with a rotational speed sensor, the user seating on the seat and treading on the pedal to drive the flywheel to rotate, and the rotational speed sensor detecting a rotational speed of the flywheel to generate the power signal.

3. The fitness equipment combining with the cloud service system of claim 2, wherein the control device is integrated with the seat to control braking and angle turning of the fitness equipment.

4. The fitness equipment combining with the cloud service system of claim 1, wherein the control device is a handle which includes a function key set to control braking and angle turning of the fitness equipment.

5. The fitness equipment combining with the cloud service system of claim 1, wherein the control device comprises a signal transmission interface.

6. A cloud service system, for fitness equipment to connect with, the fitness equipment comprising a control device, an exercise unit, a transmission module and a display module, the cloud service system comprising:
a transceiver server, receiving a control signal generated by the control device and a power signal generated by the exercise unit via the transmission module;
a computing server, establishing an exercise model according to the received control signal and the received power signal of the fitness equipment; and
a storage server, storing an information model;
wherein the computing server generates a display signal in a viewing angle designated by the fitness equipment according to the exercise model and the information model, and the display signal is inputted into the display module of the fitness equipment to generate an interactive image.

7. The cloud service system of claim 6, wherein the fitness equipment establishes a connection with the cloud service system via a verification code.

8. The cloud service system of claim 6 further comprising at least two sub-cloud service systems.

9. The cloud service system of claim 6, wherein the cloud service system is connected to a logic server group to execute service tasks, and the logic server group comprises a login server and a game server.

10. The cloud service system of claim 9, wherein the cloud system server and the logic server group are managed through a setting device.
